(19) United States
(12) Patent Application Publication
(10) Pub. No.: US 2005/0056816 A1
(43) Pub. Date: Mar. 17, 2005

(54) Pry bar

(76) Inventor: Randy J. Pieper, Merced, CA (US)

Correspondence Address: LITMAN LAW OFFICES, LTD., P.O. BOX 15035 CRYSTAL CITY STATION, ARLINGTON, VA, 22215, US

(21) Appl. No.: 10/659,352

(22) Filed: Sep. 11, 2003

(51) Int. Cl. B66F 15/00

(52) U.S. Cl. 254/25

(57) ABSTRACT

The pry bar is a tool for removing embedded fasteners or unwanted building materials having lever with a claw at one end and a handle fixedly secured along its top surface. The lever is an elongated, arcuate member that provides leverage to decrease the amount of force that needs to be applied to the pry tool. The claw is a bifurcated claw having a center notch for engaging embedded fasteners. The end of the lever having the claw has a sharp point to allow the pry tool to be wedged underneath of unwanted material. The handle is positioned in the center of the lever at the end opposite that having the claw. The handle is welded onto the lever to provide a secure fit. The lever may be made from recycle car leaf springs.

### BACKGROUND OF THE INVENTION

1. Field of the Invention

The present invention relates to pry bars and fastener removing tools and more particularly to a pry bar made by welding a handle to a recycled car leaf spring for prying purposes and for removing nails that are embedded in the surface of a building material.

2. Description of the Related Art

Many conventional prying tools exist for removing embedded fasteners as well as prying away unwanted building materials. These tools often require the user of the tool to engage the fastener or the unwanted material with a sharp claw member while applying a force to a handle portion to actuate the prying motion. The following patent documents disclose examples of existing prying tools.

European Patent Number EP 1 197 302 published on Apr. 17, 2002 discloses a pry bar. The pray bar has a claw part comprising a cross-bar extending at right angles to the shaft, and two claw noses at either end of the cross-bar, extending in the same direction. The shaft is attached to the claw and is oriented at an angle to it. A handle is provided at the other end of the shaft.

U.S. Pat. No. 5,207,126 issued on May 4, 1993 to Schaben, B. J. discloses a roof shake removal tool. The roof shake removal tool is a generally “L” shaped, rigid tool having a first planar leg plate mounted to a second arcuate leg plate, wherein the first leg plate includes a bifurcated free end defining a notch. The second leg plate includes a free end formed with a medial notch and two lateral notches positioned on either side of the medial notch to provide for multiple access to various nails and the like in removal of shingles and shakes.

U.S. Pat. No. 4,042,210 issued on Aug. 16, 1977 to Feldmann, W. F. discloses an adjustable leverage pry bar having a lever with a handle portion and pry portion connected to the handle portion in the form of an arcuate plate having a claw. Mounted on the pry portion is a fulcrum member which is movable along the arcuate plate between the claw and the handle portion for varying the angle and amount of leverage exerted by the lever.

U.S. Pat. No. 3,680,834 issued on Aug. 1, 1972 to Holloway, W. discloses a pry bar and nail puller for prying purposes, comprising an elongated steel bar. The device is hook shaped at one end with the opposite end being slightly angled and the tip of each of the ends being forked to form a nail puller.

U.S. Pat. No. 3,134,574 issued on May 26, 1964 to Reuterfors, A. S. E. discloses a pinch bar. The device includes an elongate handle with a flat blade at one end and a transversely extending blade at another end. Each blade as notch in its center for engaging fasteners. The handle also includes a nail receiving slot disposed along it to facilitate the removing of nails.

U.S. Pat. No. 1,890,273 issued on Dec. 6, 1932 to Wells, W. H. discloses a carpenter's tool for removing embedded nails. The tool comprises an elongate handle having a first end and a second end. The first end has a generally flat, straight bifurcated gripping claw with a center notch defining two adjacent gripping fingers. The second end is bent to form a hook shaped portion with a bifurcated gripping claw having a center notch defining two adjacent gripping fingers.

United States Patent Application Publication Number US 2002/0145135 issued on Oct. 10, 2002 to Macor, R. J. discloses a prying bar with a transitional portion. The prying bar comprises an elongated portion that has a longitudinal reference axis. A U-shaped hook portion with a tapered end is disposed on one end of the elongated portion. The shape of the prying bar allows for clearance for the user to grip the elongated portion of the pry bar when prying next to a work surface that is generally parallel to the longitudinal reference axis.

None of the above inventions and patents, taken either singly or in combination, is seen to describe the instant invention as claimed. Thus a pry bar solving the aforementioned problems is desired.

### SUMMARY OF THE INVENTION

The pry bar is a tool for removing embedded fasteners or unwanted building materials. The pry bar generally comprises a lever having a claw at one end and a handle fixedly secured along its top surface. The lever is an elongated longitudinal, arcuate member that provides leverage to decrease the amount of force that needs to be applied to the pry tool. The claw at the end of the lever is a bifurcated claw having a center notch for engaging embedded fasteners. The end of the lever having the claw has a sharp point to allow the pry tool to lift unwanted material. The handle is positioned in the center of the lever at the end opposite that having the claw. The handle is welded onto the lever to provide a secure fit. The lever may be made from recycled car leaf springs.

Accordingly, it is a principal object of the invention to provide a pry tool made from an arcuate lever that provides increased leverage when prying materials to limit the amount of necessary applied force from the user of the tool.

It is another object of the invention to provide a pry tool that has a secure handle to allow easy gripping of the lever during prying.

It is a further object of the invention to provide a lever having a bifurcated claw at one end for engaging embedded fasteners.

Still another object of the invention is to provide a pry tool that may be easily constructed from recycled car leaf springs.

It is an object of the invention to provide improved elements and arrangements thereof for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is an environmental, perspective view of a pry bar according to the present invention.

FIG. 2 is a perspective view of the pry bar.

FIG. 3 is a side perspective view of the pry bar showing its functional aspects.

FIGS. 4A and 4B are side and top views, respectively, of the pry bar.

Similar reference characters denote corresponding features consistently throughout the attached drawings.

### DETAILED DESCRIPTION OF THE PREFERRED EMBODIMENTS

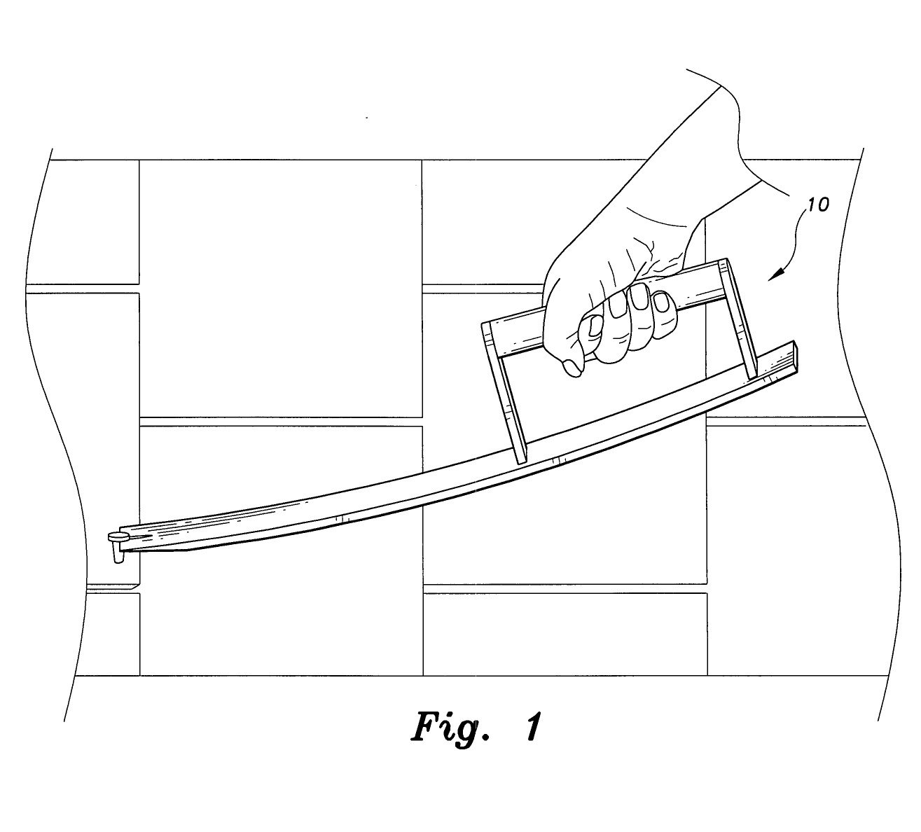

The present invention is a pry tool for removing embedded nails and unwanted building materials. FIG. 1 is an environmental, perspective view of a pry tool 10 according to the present invention. The pry tool 10 is being used to remove a fastener that is embedded in building material.

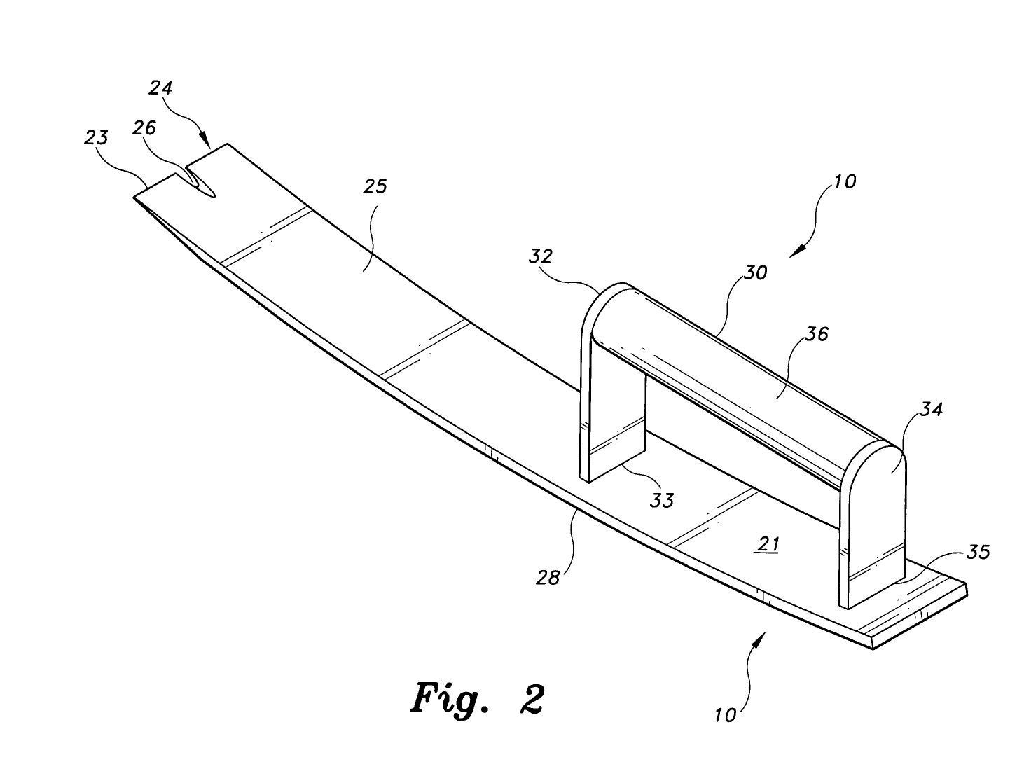

FIG. 2 is a perspective view of the pry bar detailing the individual parts of the pry bar 10. The pry bar 10 comprises a lever 20 having a longitudinal, arcuate main body with a top surface 21, a bottom surface 28, a first end 24 and a second end 22. The lever 20 forms a sharp tip 23 at its first end. The sharp tip 23 allows the lever to be easily wedged underneath of building materials that need to be lifted and removed.

The pry bar 10 further comprises a fastener engaging member 25 disposed along the first end 24 of the lever 20. The fastener engaging member 25 is a bifurcated claw (as shown in FIG. 2). The bifurcated claw has a notch 26 in the center of the first end 24 defining a pair of adjacent gripping portions.

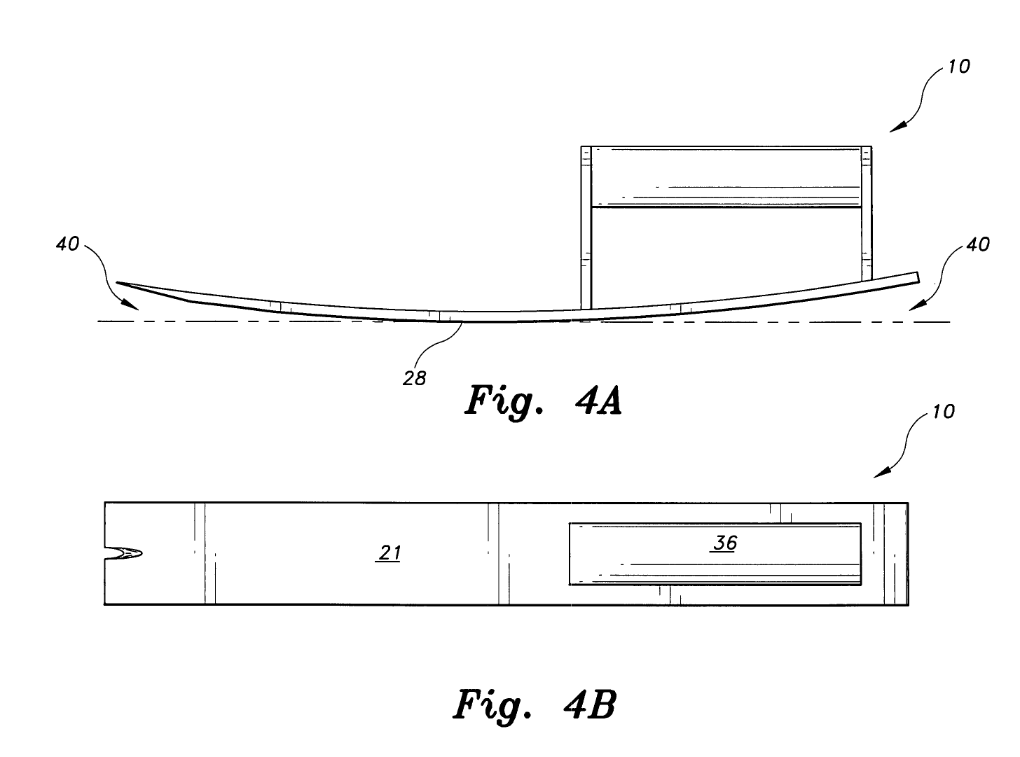

A gripping member is provided on the pry bar 10. The gripping member is preferably a handle 30 secured to the top surface 21 of the lever 20. The handle 30 comprises a horizontally disposed handle bar 36 supported by a pair of vertically oriented supports 32,34. The supports 32,34 are fixedly secured to the top surface 21 of the lever 20. The supports 32,34 are preferably welded to the top surface 21, but may be secured in any suitable manner and are not limited to being welded. The handle bar 36 is preferably a cylindrical rod that advantageously conforms to the grip of the user's hand. FIG. 4B is a top view of the pry bar 10 showing the position of the handle 30. The handle 30 is positioned in the center of the top surface 21 and adjacent the rear portion of the pry bar 10.

FIGS. 4A is a side view of the pry bar 10 showing the contour of the lever 20. The lever 20 has an arcuate main body. Because of the arcuate main body shape, the bottom surface 28 of the lever 20 does not lay even when placed on a flat surface. When the pry bar 10 is placed on a flat surface, as in FIG. 4A a space 40 is created between the flat surface and the front and rear portions of the level 20. The arcuate shape of the lever 20 provides increased leverage when using the pry bar 10 so that less force is needed from the user.

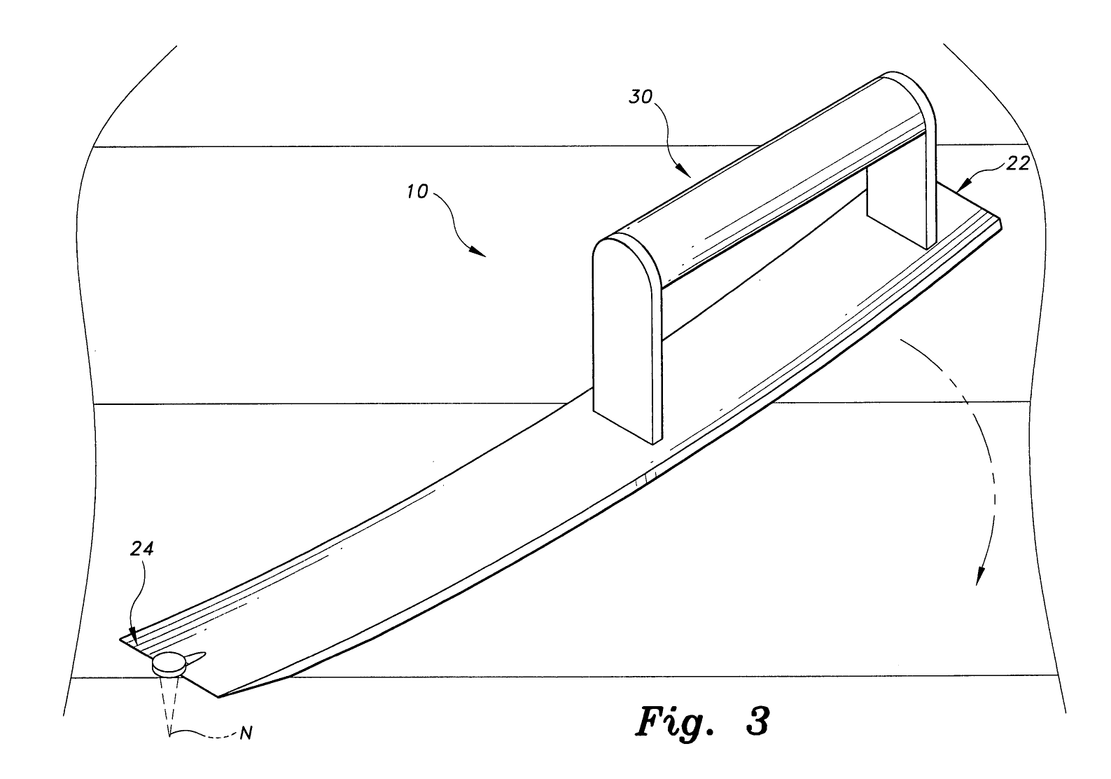

FIG. 3 is a side perspective view showing the function of the pry bar 10. In the present figure the pry bar 10 is being used to remove a nail N that is embedded in a piece of building material. The pry bar 10 engages the nail N by securing the nail N in the notch 26 of the bifurcated claw at the first end 24 of the lever 20. Once the nail N is engaged the user pushes down on the handle 30, which forces the second end 22 of the pry bar 10 downward, as indicated by the directional arrow in FIG. 3. As the second end 22 of the pry bar 10 is lowered, the first end 24 of the pry bar 10 is raised and lifts the embedded nail N from the building material.

The pry bar 10 is also used for removing unwanted building materials, such as roofing tiles or window trim material. When removing unwanted material the pry bar 10 is used in generally the same manner as described above for removing embedded nails. When removing unwanted building material the first end 24 of the lever 20 is wedged underneath the unwanted material. The sharp tip 23 allows the lever 20 to be easily wedged underneath the material. Once the lever 20 is in place, the user forces the second end 22 of the lever 20 downward by applying a force to the handle 30. As the handle 30 is forced downward the first end 24 of the lever 20 is raised and the unwanted material is pried loose.

According to the preferred embodiment of the present invention the lever 20 is made from recycled car leaf springs. The car leaf springs provide the appropriate arcuate shape and also provide suitable strength for prying functions. The size of the lever 20 will vary depending on the purpose that the pry bar 10 will be used for. A typical lever 20 is 2 inches wide, 18 inches long and 1/4 inch thick. These dimensions, however, are only exemplary and the lever 20 may be designed larger or smaller depending on its estimated usage. According to an alternate embodiment of the present invention, the pry bar 10 may be made without the handle 30 welded onto the lever 20. In certain applications it is easier to use just the lever 20 alone so the pry bar 10 may be designed without the handle 30 attached.

It is to be understood that the present invention is not limited to the embodiments described above, but encompasses any and all embodiments within the scope of the following claims.

1. A pry bar, comprising:
an elongated arcuate lever having a front end, a rear end, a top surface, and a bottom surface, wherein the top surface and the bottom surface converge at the front end to form a sharp tip for wedging the pry bar underneath material that is to be removed;
a bifurcated claw disposed along the front end of said lever having a fastener receiving notch extending through the center of the bifurcated claw defining first and second fastener engaging members located on either side of the notch; and
a gripping member fixedly secured to the top surface of said lever.

2. The pry bar according to claim 1, wherein said gripping member comprises a handle having a horizontally disposed, generally cylindrical rod supported by a pair of support members vertically disposed along the top surface of said lever.

3. The pry bar according to claim 2, wherein said vertically disposed support members are welded onto the top surface of said lever.

4. The pry bar according to claim 1, wherein said lever is a recycled car leaf spring.

5. A pry bar, comprising:
an elongated arcuate lever having a front end, a rear end, a top surface, and a bottom surface, wherein the top surface and the bottom surface converge at the front end to form a sharp tip for wedging the pry bar underneath material that is to be removed; and
a bifurcated claw disposed along the front end of said lever having a fastener receiving notch extending through the center of the bifurcated claw defining first and second fastener gripping members located on either side of the notch.

6. The pry bar according to claim 5, wherein said lever is a recycled car leaf spring.

7. The pry bar according to claim 5, further comprising a gripping member fixedly secured to the top surface of said lever.

8. The pry bar according to claim 7, wherein said gripping member is a handle having a horizontally disposed, generally cylindrical rod supported by a pair of support members vertically disposed along the top surface of said lever.

9. The pry bar according to claim 8, wherein said vertically disposed support members are welded onto the top surface of said lever.

10. A pry bar, comprising:
an elongated arcuate recycled car leaf spring having a front end, a rear end, a top surface, and a bottom surface, wherein the top surface and the bottom surface converge at the front end to form a sharp tip for wedging the pry bar underneath material that is to be removed;
a bifurcated claw disposed along the front end of said spring having a fastener receiving notch extending through the center of the bifurcated claw defining first and second fastener gripping members located on either side of the notch; and
a gripping member fixedly secured to the top surface of said spring.

11. The pry bar according to claim 10, wherein said gripping member is a handle having a horizontally disposed, generally cylindrical rod supported by a pair of support members vertically disposed along the top surface of said lever.

12. The pry bar according to claim 11, wherein said vertically disposed support members are welded onto the top surface of said lever.
